(19) United States
(12) Patent Application Publication
(10) Pub. No.: US 2005/0220943 A1
(43) Pub. Date: Oct. 6, 2005

(54) System and method for portable infant feeding

(76) Inventors: LeeAnn Abrams, Germantown, TN (US); Peter Abrams, Germantown, TN (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/077,745

(22) Filed: Mar. 10, 2005

Related U.S. Application Data
(60) Provisional application No. 60/552,913, filed on Mar. 10, 2004.

(51) Int. Cl. B65D 85/00; A21D 10/02; A61J 11/00

(52) U.S. Cl. 426/130; 215/11.1

(57) ABSTRACT

A disposable bottle for feeding babies using powdered or concentrated formula is presented. In exemplary embodiments according to the present invention, a bottle can be pre-filled with filtered water and has a neck opening that can fit nipple rings manufactured by numerous popular manufacturers. In such exemplary embodiments the disposable bottle can have a measurement indicator on its side which indicates the amount of liquid, in ounces and milliliters, associated with a given height on the bottle. In exemplary embodiments according to the present invention a disposable bottle can be filled with fluoridated water to a predetermined level, thus leaving a predetermined volume of the bottle empty and available for mixing concentrated or powdered formula. In alternative exemplary embodiments according to the present invention a disposable bottle can be packaged with a pre-measured amount of powdered formula in a sealed pouch. In alternative exemplary embodiments according to the present invention a disposable bottle can have an expandable neck which when expanded leaves a predetermined volume available for mixing concentrated or powdered formula or other comestible solute.

### CROSS-REFERENCE TO RELATED APPLICATIONS

This application claims the benefit of U.S. Provisional Patent Application Ser. No. 60/552,913 filed on Mar. 10, 2004, which is hereby fully incorporated by reference herein.

### TECHNICAL FIELD

The present invention relates to food packaging and delivery systems, and in particular to an improved method and system for bottle-feeding babies.

### BACKGROUND OF THE INVENTION

Traditional methods of bottle-feeding babies with powdered formula present a number of obstacles, in both the preparation as well as the feeding processes. Normally, reusable bottles and nipples must be purchased, washed (if not boiled), filled with either tap water (which can involve concerns of taste, odor, temperature and possibly safety) or bottled water (which must be separately purchased—and which often lacks fluoride) and then have formula added and mixed in. Whereas while at home a traditional bottle-preparer can always either get another bottle, or clean (and possibly sterilize) a used bottle, while traveling, carrying extra bottles or even cleaning ones that were previously used can be cumbersome. In addition, while on the go it is necessary to either carry bottled water or find a place to get acceptable tap water. Besides such logistical problems, reusable bottles can be expensive.

The alternative, pre-mixed disposable bottles of liquid formula, are also well known. However, to most families their cost is simply prohibitive. For example, individual pre-mixed single use bottles of liquid formula are available in 2 and 4 oz. bottles in many retail outlets, such as supermarkets, convenience stores, etc. A case of an exemplary brand's 24 4 fl oz. bottles can cost approximately $71.00. Containers of 32 fl oz. of pre-mixed formula can cost approximately $41.00 for a case of six. On the other hand, powdered formula can cost approximately $22.00 for enough to make 268 fl oz. of formula. This respectively equates to $5.29 per 8 oz serving for individual pre-mixed bottles, $1.71 per 8 oz serving for large pre-mixed containers and $0.66 per 8 oz serving for powdered formula. Besides cost, pre-mixed liquid formula presents another problem as well. As, soon as pre-mixed formula is opened any unused portion must be refrigerated. Even when preserved, it often loses its freshness after a short time.

What is thus needed in the art is a convenient and cost effective method for bottle-feeding babies, whether at home or on the go, that can solve the above-described problems with conventional feeding methods.

### SUMMARY OF THE INVENTION

A disposable bottle for feeding babies using powdered or concentrated formula is presented. In exemplary embodiments according to the present invention, a bottle can be pre-filled with filtered water and has a neck opening that can fit nipple rings manufactured by numerous popular manufacturers. In such exemplary embodiments the disposable bottle can have a measurement indicator on its side which indicates the amount of liquid, in ounces and milliliters, associated with a given height on the bottle. In exemplary embodiments according to the present invention a disposable bottle can be filled with fluoridated water to a predetermined level, thus leaving a predetermined volume of the bottle empty and available for mixing concentrated or powdered formula. In alternative exemplary embodiments according to the present invention a disposable bottle can be packaged with a pre-measured amount of powdered formula in a sealed pouch. In alternative exemplary embodiments according to the present invention a disposable bottle can have an expandable neck which when expanded leaves a predetermined volume available for mixing concentrated or powdered formula or other comestible solute.

### BRIEF DESCRIPTION OF THE DRAWINGS

FIGS. 1A-1C depict exemplary conventional bottles used for baby feeding;

FIGS. 2A-2B depict exemplary conventional types of powdered formula;

FIGS. 3A-3C depict exemplary conventional baby bottle nipple types;

FIGS. 4A-4C depict example disposable water bottles according to exemplary embodiments of the present invention;

FIGS. 5A-5B depict water bottle adapters according to an alternate exemplary embodiment of the present invention;

FIG. 6 depicts an exemplary multiple unit pack of disposable bottles according to an exemplary embodiment of the present invention;

FIG. 7 depicts an exemplary multiple unit pack of disposable bottles according to an alternate exemplary embodiment of the present invention;

FIG. 8 depicts an exemplary multiple unit pack of disposable bottles according to yet an alternate exemplary embodiment of the present invention;

FIGS. 9A-9C depict detailed views of the exemplary labels for the individual bottles depicted in FIGS. 6-8, respectively;

FIG. 10 depicts various views of a disposable water bottle cap according to an alternate exemplary embodiment of the present invention which has a pre-measured amount of powdered formula included in a sealed pouch;

FIG. 11 depicts a disposable water bottle according to another alternate exemplary embodiment of the present invention which has an expandable neck; and

FIGS. 12A-B depict the disposable water bottle of FIG. 11 with the expandable neck in a compressed and an angled position.

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

This present invention provides a novel system and method for the convenient, efficient, nutritious and safe bottle-feeding of babies either at home or while traveling. The present invention solves the problems inherent in the prior art by providing a bottle preparer with the convenience, economy, efficiency and safety of prepackaged disposable bottles which are filled with the exact amount of pure and fortified water and whose necks are inter-operable with a nipple and ring of their choice.

In exemplary embodiments according to the present invention, a properly sized disposable bottle can be filled with an indicated precise amount of water. The water can be, for example, filtered and fortified with fluoride. All a caregiver needs to do is add powdered formula and provide a chosen nipple and ring to feed their baby. In exemplary embodiments according to the present invention the bottles can be, for example, disposable, and can, for example, have different neck openings (as to diameter, height, number and type of threads, etc.) so as to be compatible or inter-operable with a variety of nipples and nipple rings commonly available to consumers. Such an exemplary bottle, can, for example, have markings on the side, in both milliliters and ounces, to indicate both how much is available to feed a baby as well as how much formula has been consumed.

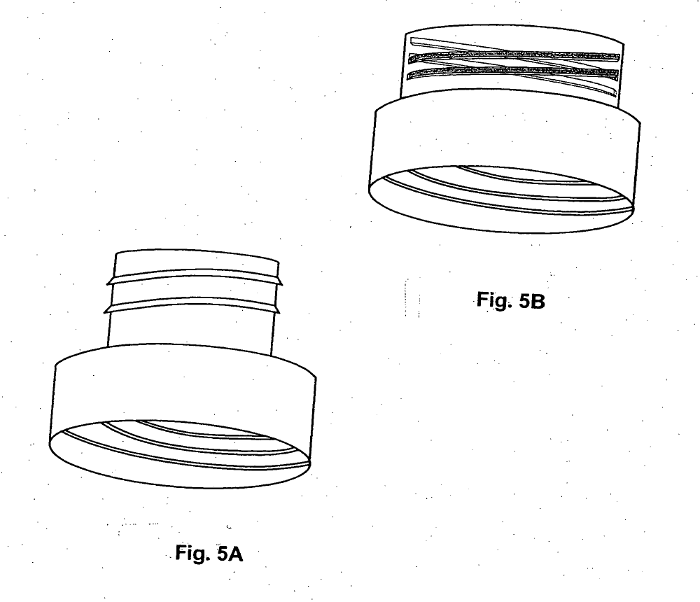

In alternative exemplary embodiments according to the present invention, bottles can have a neck opening of a single size and type and can, for example, be provided with one or more adapters that interface between such one type of neck opening and a variety of nipple rings, as illustrated in FIG. 5 and described more fully below.

In exemplary embodiments according to the present invention bottles can be somewhat larger in volume than the volume of water they contain in order to leave room for adding formula (powdered, liquid concentrate, etc.) and mixing it with the water.

As noted above, prior art methods of bottle feeding present difficulties. Pre-mixed liquid formula in disposable bottles is expensive, and thus often impractical for most families. Mixing formula concentrates (powdered, liquid or otherwise) is often messy; it requires cleaning bottles, finding and adding water, storing the concentrate, etc.

In exemplary embodiments according to the present invention, these prior art difficulties are obviated. With, for example, a 12 or 24 pack of 8 oz. or 4 oz. disposable water bottles, some formula concentrate, and any nipple and ring of their choice, a baby's caregiver is ready to feed. Because manufacturers sell nipples and rings separately from bottles, the cost of a reusable bottle is thus saved. An important difference between systems according to the present invention and prior art systems is that such conventional systems use nipples and rings that (i) are either specific to their product or (ii) are of the generic small size type. By contrast, in exemplary embodiments according to the present invention, a consumer can choose any major brand nipple and ring that suits them and affix it to a disposable bottle of water. Because the nipple is the most personal part of the bottle feeding process this feature is significant and desirable to consumers. Nipples come in a variety of shapes and types. For example, there are large, small, slow, fast, orthodontic and “natural” types of nipples, to name a few. Thus, in exemplary embodiments according to the present invention, the need for buying reusable bottles and the associated task of loading a dishwasher with numerous bottles for the next day's feedings are eliminated.

Conventional disposable bottled water closures cannot accept common types of nipple rings for baby bottle feeding. The neck openings, sizes, heights and thread types are not compatible with water bottles marketed to adults or older children. In addition, bottled water does not generally have measurement indicators to allow for the proper mixing of formula, nor do they leave room to mix in any formula.

In alternative exemplary embodiments according to the present invention, bottles can be marketed with disposable nipples and single use serving formula packets, providing an all-in-one package.

Thus, in exemplary embodiments according to the present invention bottles can have measurement indicators, can be filled with fluoridated, fortified and/or nutritional water, and can be designed to fit the sizes of the various nipple rings available on the market. This combination of features lets a consumer mix the convenience of pre-mixed formula in disposable bottles with the economy and convenience of bottled water, and the nipple choice that best suits their individual needs.

In exemplary embodiments according to the present invention bottles can be provided with, for example, various different size neck openings to accommodate the various sizes of nipple rings available, or, for example, can be provided with a single size neck opening and adapters to interface with the various nipple rings available.

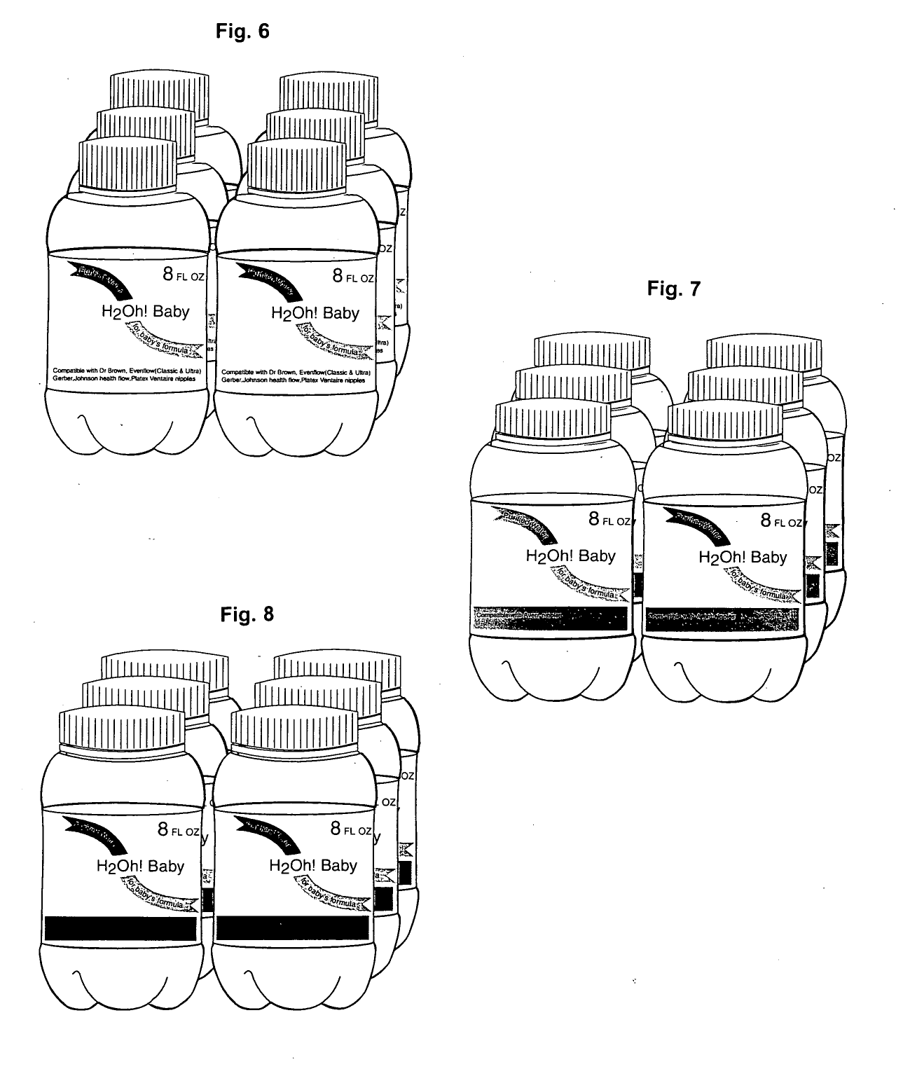

Most nipple rings currently on the market that use the small type of nipple ring, such as, for example, those marketed by Dr. Brown™, Evenflow™, Gerber™, Johnson and Johnson™ and Playtex™, each have a mutually compatible neck opening and threading (this type was referred to above as the “generic” small nipple type). However, as regards large neck openings, there are two common sizes, and two types of threads common to the major brands. For example, Avent™ has one size and Gerber™ and Playtex™ have a common different size. Thus in exemplary embodiments of the present invention, bottles or adapters can be produced in three types of neck openings to accommodate all of the major brands currently on the market. The different sizes can be easily identifiable, having, for example, color coded packaging that lists the nipple rings that are compatible with each size. These embodiments are illustrated in FIGS. 6-8, as described below For example, a consumer could buy a 12 pack of 8 oz. disposable bottles of fortified water that fits a ring and nipple that she already owns or that she will purchase.

Alternatively, bottled water can be provided in bottles with a single neck opening and thread size and type that is compatible with one of the common nipple types, along with one or more nipple ring adapters that can be screwed on top of the bottle to allow for inter-operability with other nipple rings. Two examples of such adapters are shown in FIG. 5. According to these exemplary embodiments a supplier can, for example, easily change adapters or manufacture new ones if a new brand emerges or a current popular brand changes its neck opening and/or thread.

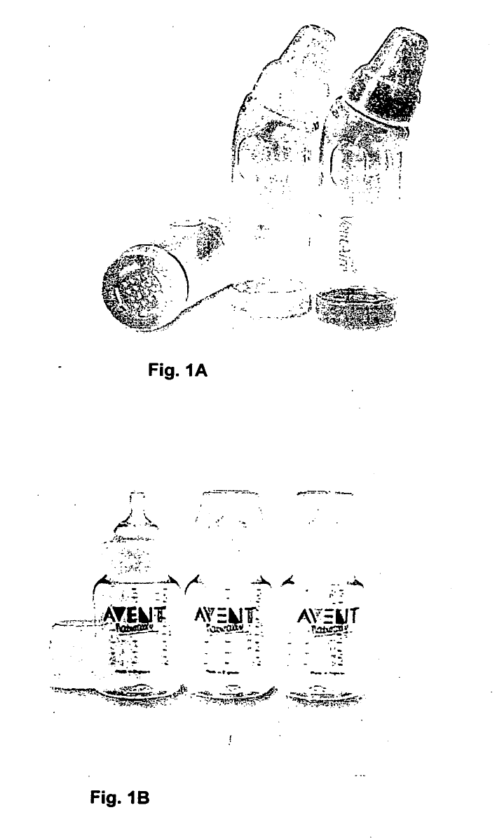

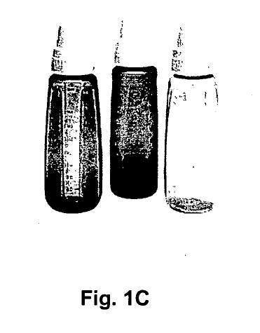

FIGS. 1-3 illustrate conventional products for bottle feeding babies using powdered formula and reusable bottles. FIG. 1A depicts a conventional non-disposable 9.0 oz. Playtex Ventilaire™ reusable bottle. FIG. 1B depicts exemplary Avent 9.0 oz. non-disposable bottles fitted with slow flow nipples and FIG. 1C depicts Playtex Fashion Tints™ 9.0 oz. colored non-disposable bottles. As can be seen from FIG. 1, each of these conventional bottles comes with a corresponding particular nipple ring which is fastened to the bottle and which is used to hold a nipple in place on top of the bottle during feeding.

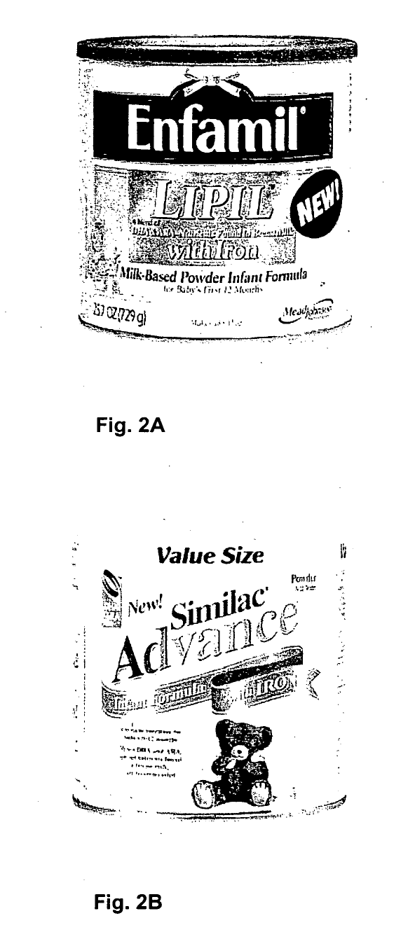

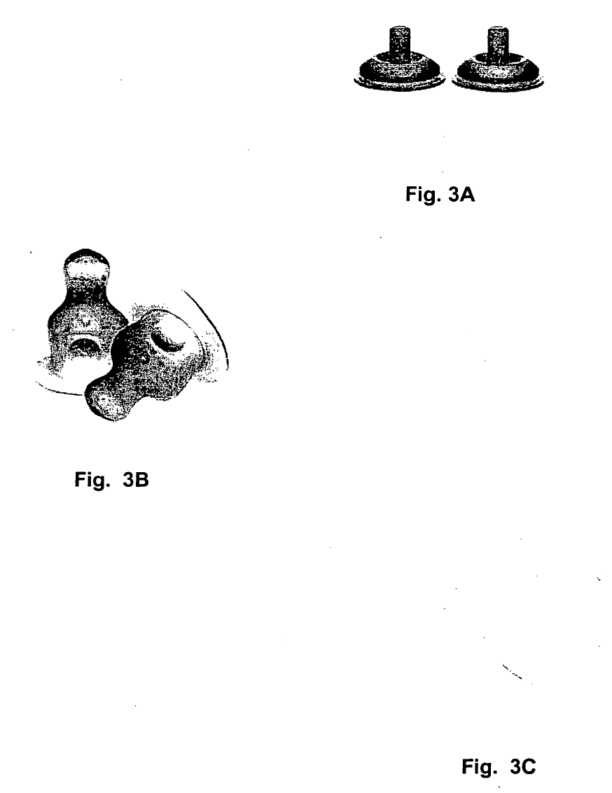

FIGS. 2A and 2B depict exemplary types of powdered formula commonly in use, such as, for example, Enfamil™ and Similac™, respectively. Finally, FIGS. 3A-3C depict conventional nipples commonly in use. FIG. 3A is an exemplary nurser type nipple, FIG. 3B is an exemplary Gerber™ type nipple, and FIG. 3C depicts an exemplary Playtex™ nipple. These nipples fit into corresponding nipple rings.

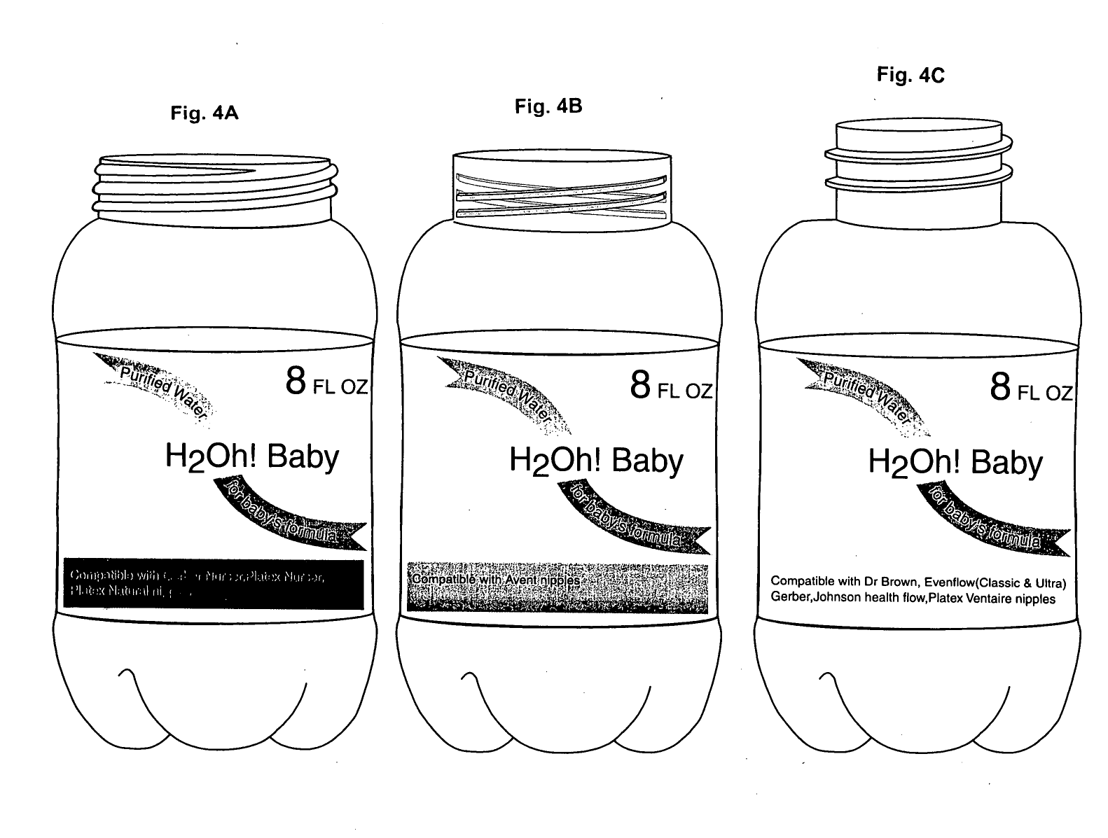

FIGS. 4A-4C depict three examples of disposable bottles according to exemplary embodiments of the present invention. FIG. 4A depicts an exemplary disposable water bottle with a large neck opening and straight neck threads, such as is compatible with the Gerber™ and Playtex™ type nipple rings. FIG. 4B depicts an exemplary disposable water bottle with a large opening and angled neck threads, such as is compatible with Avent™ type nipple rings, and FIG. 4C depicts an exemplary disposable water bottle with the small type opening and straight neck threads, such as is compatible with Gerber™, Playtex™, Evenflow™, Dr. Brown™ and Johnson and Johnson™ small type nipple rings. For illustrative purposes only, exemplary dimensions for the exemplary bottles depicted in FIG. 4 can be, for example, a diameter of approximately 2 3/32″ for the bottle of FIG. 4A; a diameter of approx. 1⅞″ for the bottle of FIG. 4B, and a diameter of approx. 1 7/16″ for the bottle of FIG. 4C. In general, bottle dimensions, size, and threading type can be varied as may be desirable to accommodate nipple rings and nipple types as may be offered in the market place.

As noted, the threads on the exemplary bottles depicted in FIGS. 4A and 4B are different. The threads of the depicted exemplary bottle of FIG. 4B are at more of an angle and do not continue all the way around the bottle. There is also a greater distance from the top of the bottle to the beginning of the threads requiring a nipple ring that is deeper or taller.

As described above, in alternate exemplary embodiments according to the present invention, instead of providing an assortment of bottles, where each is compatible with one nipple ring type, a single bottle compatible with the most common nipple ring, can be provided, with adapters to accommodate the various other nipple ring types. FIG. 5 depicts such adapters according to alternate exemplary embodiments of the present invention. Both exemplary adapters depicted in FIG. 5 fit on the large neck Gerber™ and Playtex™ type opening shown in FIG. 4A. The adapter shown in FIG. 5A interfaces to a nipple ring compatible with the small “generic” neck opening shown in FIG. 4C, and the adapter shown in FIG. 5A interfaces to the large neck opening. Avent™ type bottle shown in FIG. 4B. Other adapter configurations can be implemented as may be desirable.

FIGS. 6-8 respectively depict an exemplary multi-unit 6 pack of 11.5 oz. bottles filled with 8 oz. of fluoridated water according to exemplary embodiments of the present invention. The bottles in an exemplary multi-pack can be provided with, for example, plastic rings to hold them together and a plastic handle for carrying, using conventional packaging techniques. Three sets are shown FIGS. 6-8 to illustrate what can, for example, be displayed on a store shelf. Each bottle, for example, could have a label which is color coded to easily identify compatibility with different brands of nipple rings. Other packaging options for the bottles could be, for example, in 12 or 24 packs, and exemplary packages can contain, for example, 24 and 12 bottle packs of 6.5 oz. bottles containing 4 oz. of water in each bottle.

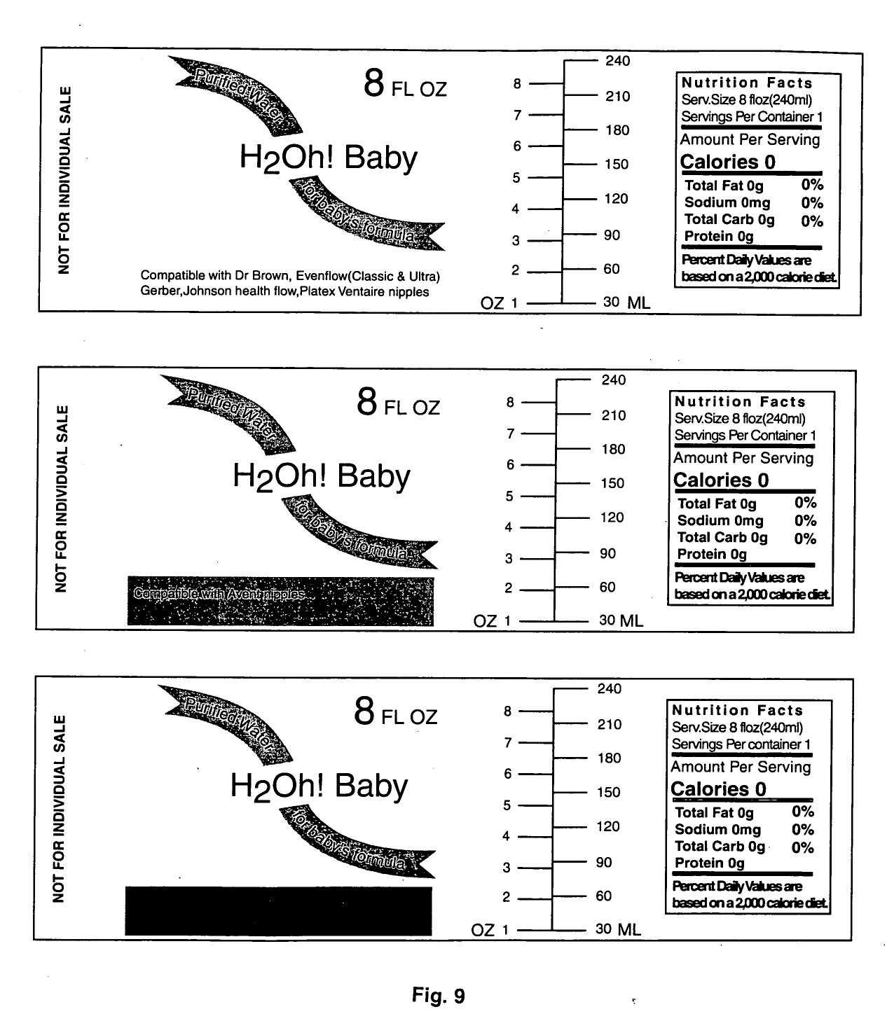

FIG. 9 depicts the detailed and enlarged views of the bottle labels shown in FIGS. 6-8, respectively. The field or background of the labels can be transparent, so that the liquid level can be seen when looking at the height markings. Alternatively, the field can be opaque, except for that portion which is behind the height markings, which can be transparent.

As can be seen, each label can have, for example, a notification as to which types of nipple rings are compatible with the bottle. This is reinforced by a particular color being associated with each neck opening type for easy recognition on store shelves.

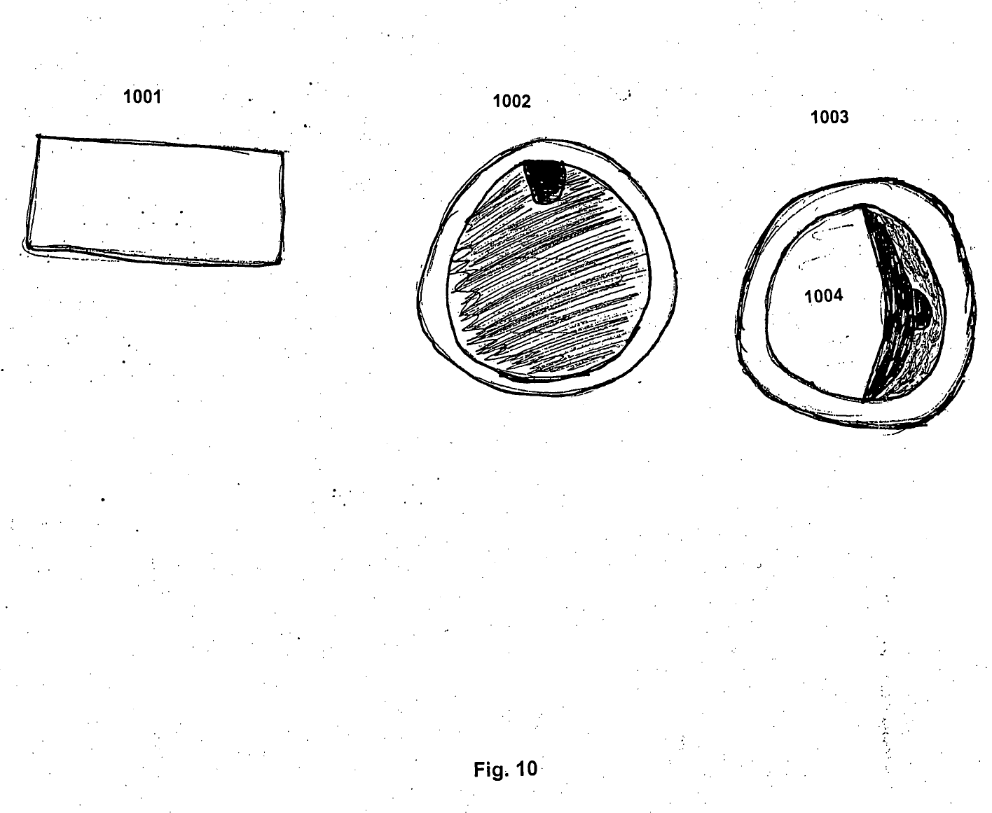

FIG. 10 depicts an alternative bottle cap according to an alternate exemplary embodiment of the present invention, where powdered formula can be included with each bottle sealed in its cap. In such embodiments there can, for example, be an adaptation of a regular bottle top which is made taller (i.e., deeper) than normal so as to have a cavity into which the formula can be inserted.

With reference to FIG. 10 such an exemplary water bottle cap 1001 is shown. The underside of the cap 1001 is depicted at 1002 and 1003. 1002 depicts the closed underside of the cap, showing alternatively a foil tab and seal that can cover the formula. This foil is what faces the air pocket at the top of the bottle when the cap is affixed to the bottle, and provides an air-tight and water-tight seal. 1003 depicts the underside of the bottle top with the foil tab pulled back, showing the cavity which contains the powdered formula 1004 underneath. Alternatively, the foil opening can be, for example, on the top of the cap, or alternatively, for example, the entire container for the powder can be a separate container which is removably attached to the bottle cap, such as for example, by small plastic prongs which are easily broken.

Alternatively still, other arrangements of the cavity in the cap, or a container for the dry formula separate from but removably attached to a plastic cap, can be implemented, with varying methods of accessing and sealing the powdered formula, as may be known in the art. As well, other ingredients besides powdered formula can also be packaged in the cap, as may be desirable, such as for example, lemonade mix, juice or other concentrate of various types, and in general anything that a user may desire to mix with the bottled water at the time of feeding or consumption.

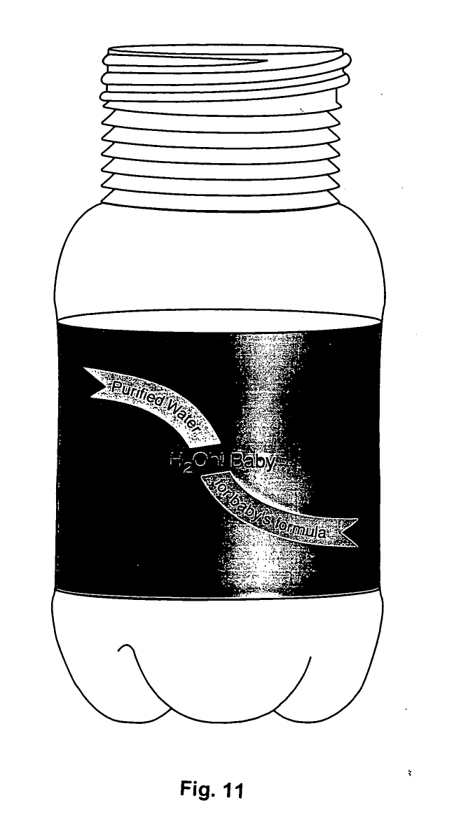

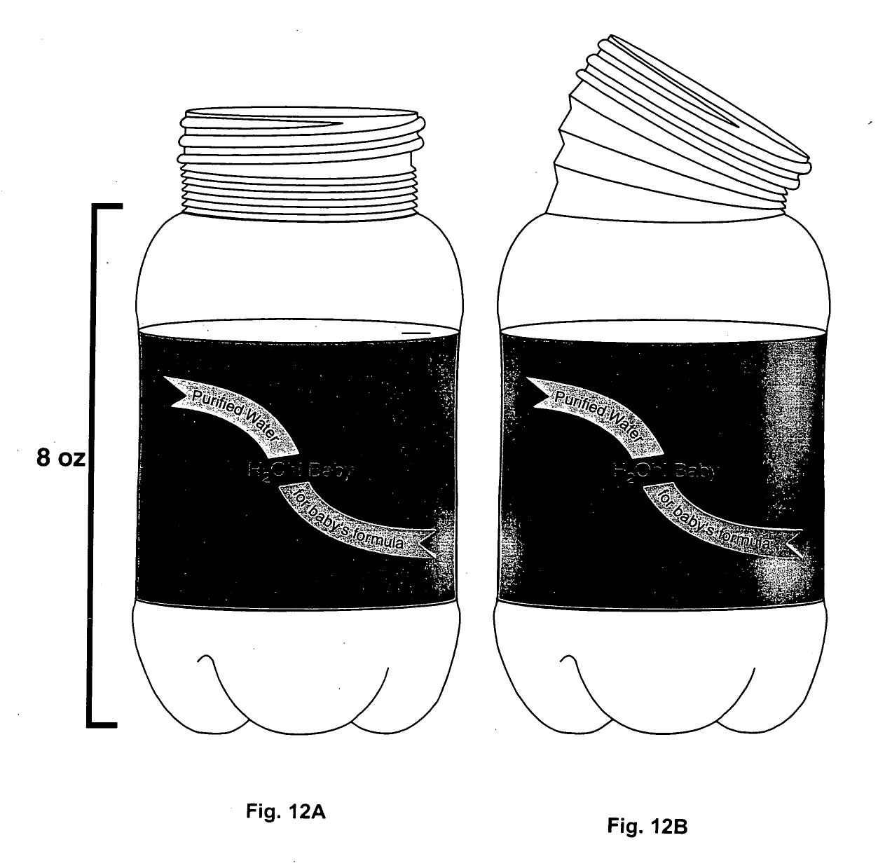

FIGS. 11-12 depict an alternate exemplary embodiment according to the present invention, as next described. Instead of having a bottle of a given capacity, for example 11.5 oz, and filling it with water to less than that capacity, such as, for example, by filling an 11.5 oz bottle to only 8 oz, so as to leave room for adding formula and mixing, in the exemplary embodiment of FIGS. 11-12 a bottle can be filled to its exact capacity from the bottom of the bottle to the bottom of the neck opening. Thus, the bottles can, for example, be filled normally and appear as other bottles of water on the market except for certain unique neck opening, shape, and design features. A unique feature of a bottle according to this exemplary embodiment of the present invention is depicted in FIGS. 11-12 where the neck of the bottle is shown as expandable. FIG. 11 shows an exemplary neck in an expanded state, FIG. 12A in its compressed state, and FIG. 12B in an angled extended state. The expandable neck can, for example, allow the user to pull up on the top and extend the neck to allow for the addition of formula (or juice concentrate or other comestible solutes) and for room for mixing. This obviates the need to leave an air gap in the bottle for these purposes.

FIG. 12(b) depicts another benefit of the flexible neck. It allows the neck to be angled, for example, in order to permit a more upright feeding position and still maintain a constant, positive flow of liquid to the nipple to prevent air from mixing into the flow which can cause an increased likelihood of regurgitation.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although the inventive concept was described in the context of bottle feeding babies, the invention is applicable to any food packaging and delivery system in which some concentrated foodstuff is added to a liquid, such as water, as a pre-requisite to its final preparation or consumption.

1. A disposable bottle, comprising:
a bottle;
a neck opening; and
a cap;
wherein the bottle is filled with a quantity of water such that a volume of air remains so that the bottle can hold the quantity of water and a single serving of powdered formula or other comestible solute, and
wherein the neck opening is arranged so as to fit one or more commonly available nipple rings.

2. The disposable bottle of claim 1, wherein the quantity of water is filtered and/or fluoridated.

3. The disposable bottle of claim 1, wherein the neck opening is arranged to fit at least one size of nipple rings manufactured by at least one of Avent, Gerber, Playtex, Evenflow and Dr. Brown.

4. The disposable bottle of claim 1, further comprising a measurement indicator on the side either embossed or engraved in the bottle or on a label affixed to the bottle indicating amounts of liquid in ounces and milliliters associated with various heights.

5. The disposable bottle of claim 2, where said fluoridated water is filled to a level which leaves 1¾ ounces of volume available for mixing.

6. The disposable bottle of claim 2, where said fluoridated water is filled to a level which leaves between 1 and 3 ounces of volume available for mixing.

7. The disposable bottle of claim 1, further provided with a color coded label or top so as to indicate compatibility with one or more nipple ring types.

8. The disposable bottle of claim 1, wherein the neck opening is arranged to fit a first type of nipple rings which will accept an adapter to fit a second type of nipple rings.

9. The disposable bottle of claim 8, wherein the adapter is either disposable or reusable.

10. The disposable bottle of claim 1, wherein the cap has a cavity in which powdered formula can be filled and sealed.

11. The disposable bottle of claim 10, wherein the cap is filled with at least one of a single serving of powdered formula, juice concentrate or other comestible solute.

12. The disposable bottle of claim 1, wherein the water is fortified with vitamins, minerals or other nutrients.

13. A disposable bottle, comprising:
a bottle;
an expandable neck opening; and
a cap;
wherein the bottle is filled with a quantity of water such that when the neck opening is expanded a volume of air is available so that the bottle can hold the quantity of water and a single serving of powdered formula or other comestible solute, and
wherein the neck opening is arranged so as to fit one or more commonly available nipple rings.

14. The disposable bottle of claim 13, wherein the quantity of water is filtered and/or fluoridated.

15. The disposable bottle of claim 13, wherein the neck opening is arranged to fit at least one size of nipple rings manufactured by at least one of Avent, Gerber, Playtex, Evenflow and Dr. Brown.

16. The disposable bottle of claim 13, further comprising a measurement indicator on the side either embossed or engraved in the bottle or on a label affixed to the bottle indicating amounts of liquid in ounces and milliliters associated with various heights.

17. The disposable bottle of claim 13, further provided with a color coded label or top so as to indicate compatibility with one or more nipple ring types.

18. The disposable bottle of claim 13, wherein the neck opening is arranged to fit a first type of nipple rings which will accept an adapter to fit a second type of nipple rings.

19. The disposable bottle of claim 18, wherein the adapter is either disposable or reusable.

20. The disposable bottle of claim 13, wherein the cap has a cavity in which powdered formula can be filled and sealed.

21. The disposable bottle of claim 20, wherein the cap is filled with at least one of a single serving of powdered formula, juice concentrate, or other comestible solute.

22. The disposable bottle of claim 13, wherein the water is fortified with vitamins, minerals or other nutrients.
